(19) United States
(12) Patent Application Publication
(10) Pub. No.: US 2018/0124472 A1
(43) Pub. Date: May 3, 2018

(54) Providing Interactive Content to a Second Screen Device via a Unidirectional Media Distribution System

(71) Applicants: Paul Staff, New York, NY (US); Jonathon Staff, Santa Clara, CA (US)

(72) Inventors: Paul Staff, New York, NY (US); Jonathon Staff, Santa Clara, CA (US)

(21) Appl. No.: 15/800,423

(22) Filed: Nov. 1, 2017

Related U.S. Application Data
(60) Provisional application No. 62/416,630, filed on Nov. 2, 2016.

(51) Int. Cl. H04N 21/6543; G06F 17/30; H04N 21/41; H04N 21/435; H04N 21/233; H04N 21/439; H04N 21/2368; H04N 21/81

(52) U.S. Cl. CPC H04N 21/6543; G06F 17/30026; H04N 21/4126; H04N 21/8133; H04N 21/233; H04N 21/439; H04N 21/2368; H04N 21/435

(57) ABSTRACT

Embodiments of the subject invention are directed to a computer-implemented method and system for interacting with unidirectionally distributed content, including specifying an interaction manifest that corresponds to an item of unidirectional content, generating a corresponding interaction ID and an ID sound code, embedding the ID sound code in the audio portion of the corresponding item of unidirectional content, playing the item of unidirectional content which includes the embedded ID sound code, decoding, by a mobile device in proximity to a player the embedded ID sound code, requesting the corresponding interaction manifest and executing the interaction manifest.

### TECHNICAL FIELD

Various embodiments generally relate to a method and system for providing interactive content to mobile devices that corresponds to unidirectional content that is separately played by a content player.

### BACKGROUND

Broadcast television, along with other types of video and audio content distribution channels such as cable, satellite, radio, DVDs, MP3s, etc.), is currently a one-way medium, with content that is intended solely for consumption. There is no method available within the distribution channel for a user to interact with the content provided through the distribution channel, for example to provide feedback or obtain related information. What limited feedback that is currently available is highly valued, as it provides the basis for content ratings and advertisement pricing.

One challenge to creating effective interaction with content is to identify what content is currently being consumed and what scene is playing. For example, viewers may find it beneficial to access biography information about a guest actor during a television show. However, this information is only relevant during scenes in the show where the guest actor is on-screen. Therefore, it would be advantageous to be able to provide information about the guest actor during scenes in which he/she is present. It would further be advantageous to make information about viewer interactions with the content available for producers. For example, information such as whether the viewer watched an entire episode and whether the view showed a particular interest in the guest actor would be of interest.

One approach to providing information related to an item of unidirectional content being broadcast is to display the related information on a second screen device, i.e. a device that provides a different display or screen from the television or device that is displaying the content. The second screen device may be a personal computer, a mobile device or any other connected, computer-based, device.

There are currently several products in place that are designed to provide a second screen experience for viewers watching content. Some of these products identify the content being consumed by analyzing the audible audio stream (e.g., VIGGLE, WYWY) and others are intended for use while content is being viewed, but require the viewer to identify the content (e.g., proprietary apps such as AMC's WALKING DEAD app). These methods for content identification can be inaccurate, possibly frustrating users and providing bad data to producers.

Feedback about distributed content is already collected and used for purposes such as determining content ratings or setting the price of advertisements played with the content. For television, the primary source of consumer data is the Nielsen Company, LLC, of New York, N.Y. A number of other firms also provide data collection and content feedback services. However, data provided by such companies is typically based on a small sample size of viewers and is only an approximation of the people consuming content; further, custom hardware is typically installed for each sample viewer.

Lastly, there are applications that utilize ultrasonic audio signals to communicate information, such as the setup process for GOOGLE CHROMECAST, which uses ultrasonic audio signals to facilitate device connection to a Wi-Fi network. However, this technology has not been utilized for second screen applications.

Thus, it is with respect to these considerations and others that the present invention has been made.

### SUMMARY OF THE DESCRIPTION

The objective of the subject invention is to create an interactive second screen experience that enables viewer engagement and the collection of data for producers.

In certain embodiments, the subject invention embeds an inaudible ultrasonic signal in the audio stream of content that is detectable by a viewer's mobile device. This signal allows for accurate content identification and results in relevant interactions for viewers and reliable data for producers.

In certain embodiments, an ultrasonic audio signal, embedded with the audio portion of content, is played during a scene to direct a viewer's mobile device to display information relevant to the scene. At the end of the scene, another ultrasonic signal informs the mobile device to stop showing the scene-related information.

The subject invention has three primary capabilities: 1) a second screen experience for viewers, 2) direct, accurate feedback for producers, and 3) content identification and delivery via ultrasonic signals. Combined into a system, these concepts create a novel way for producers and viewers to interact with unidirectionally distributed content.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a generalized block diagram of a system that provides interactive content to a viewer using a mobile device within a unidirectionally distributed media environment.

FIG. 2 is a generalized block diagram of a method that provides interactive content to a viewer using a mobile device within a unidirectionally distributed media environment.

FIG. 3 is a system diagram that shows components of one exemplary environment in which the invention may be practiced.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Unidirectional media, or unidirectional content, distribution refers to the distribution, transmission, or broadcasting of media items, such as a television or radio programs where the flow of data is generally unidirectional, from a distributor to a device, referred to herein as a content player, which shows or plays the media or content for a viewer. Delivery methods include traditional broadcast television/radio, cable/satellite, over-the-top (OTT) streaming, and content delivered without a direct pipeline back to the distributor. Delivery methods further include physical distribution of DVDs, CDs, MP3 files, etc.

Producer or content producer refers to a person, studio or agency that creates content to be broadcast or otherwise distributed to viewers. Example producers include movie studios, television studios, radio studios, and independent producers of media.

Distributor refers to an organization, a facility, or a service that distributes unidirectional content created by content producers to viewers. In some instances, the producer and distributor may be the same entity (e.g., a broadcast network that both creates and distributes the content). The term distributor encompasses traditional broadcasters such as television and radio broadcasters, cable and satellite distributors, distributors of OTT media, and also includes physical distribution approaches such as distribution of DVDs and CDs through retail, direct and other sales channels.

Content player refers to a device that plays media or content distributed by unidirectional media, or content, distribution. Examples include televisions, radios, specialized video and audio players, personal computers, and mobile devices.

Interaction manifest—refers to a specification of an action or sequence of actions to be performed or played by a mobile device. An interaction manifest can specify a simple action, such as displaying a piece of information to a viewer at a specific time. For example, an interaction manifest it may describe a complex interaction, such as voting for a contestant or purchasing a product. An interaction manifest may correspond to a single item of unidirectional content such as a television program; or it may correspond to a segment or subset of the content, such as a scene in a television program or an act in an opera or play.

Viewer refers to a person that watches, listens to, or otherwise consumes unidirectional content played by a content player. Viewers typically are in possession of a mobile device, with a mobile device application, or “app”, downloaded, installed, and in operation on the mobile device while content is being consumed.

Venue refers to a physical location where a viewer consumes unidirectional content. This may be a house, an office, a room or other location. Generally, the venue enables the mobile device of a user to receive an acoustic signal from a content player that is within or near to the venue.

### Generalized Operation

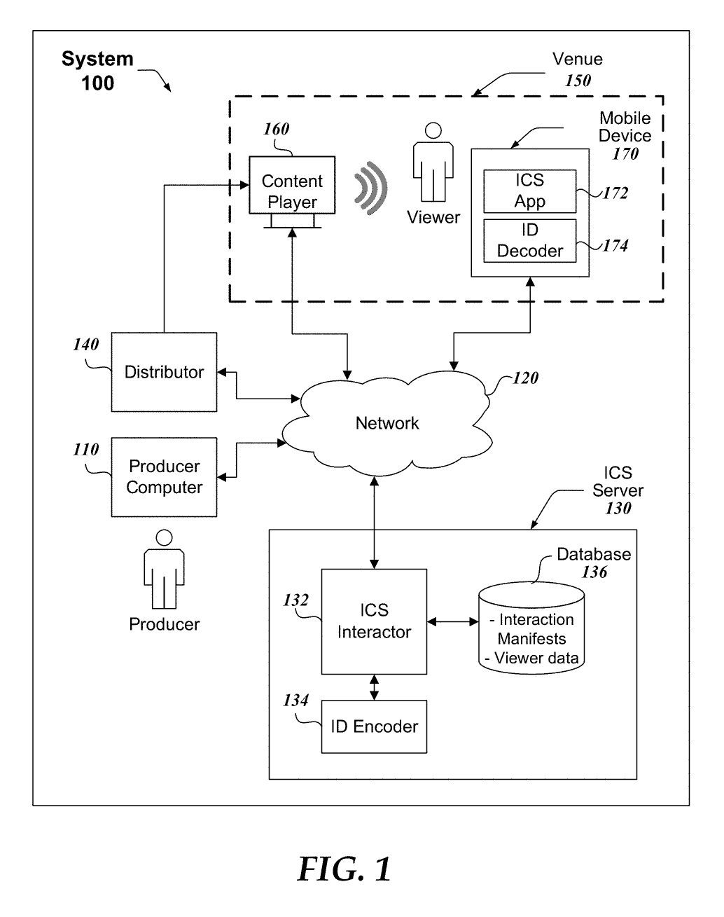

The operation of certain aspects of the invention is described below with respect to FIGS. 1-3.

FIG. 1 is a generalized block diagram of a system 100 for providing interactive content within a unidirectional media distribution environment. System 100 includes a client computer, referred to as producer computer 110, which is used by a human, also referred to as a producer, to create an interaction manifest that specifies a sequence of actions that may include interactions between a viewer using a mobile device 170 and a server 130. Typically, an interaction manifest is associated with, or corresponds to, a particular item of unidirectional content such as a movie, television program, musical recording, etc. that is distributed to and played by content player 160 for the viewer. In certain embodiments, producer computer 110 creates the final form of the associated content, as is discussed hereinbelow.

Producer computer 110 refers to a personal computer, tablet computer, or other interactive device that is used by a producer to create an interaction manifest for an item of unidirectional content. In certain embodiments, the producer uses an interaction creation program running on producer computer 110, such as a web-based client application that runs in a browser, to create an interaction manifest. The interaction manifest is stored in one or more computer files and is stored by server 130 in an interaction manifest database 136.

Server 130 runs a server program, referred to as the interactive content system (ICS) interactor 132 that enables producer computer 110 to create and store an interaction manifest that corresponds to an item of unidirectional content. In addition, when an interaction manifest is first stored, ICS interactor 132 generates a unique identification (ID) code for it, referred to as an interaction ID. In certain embodiments, an interaction ID is an alphanumeric string. ICS interactor 132 then uses an encoding device or program, referred to as ID encoder 134, to generate a sound file, referred to as an ID sound code, that represents an interaction ID acoustically. In certain embodiments, the range of frequencies used to represent an interaction ID are in the ultrasonic range. For example, different alphanumeric characters can each be assigned a different frequency within the ultrasonic range, in which case an ID sound code corresponds to a sequence of tones in the ultrasonic range, each tone lasting for a predetermined time period. With this approach, when the ID sound code is multiplexed with ordinary acoustic files the sequence of sounds contributed by the ID sound code are inaudible to a viewer. For this approach to work, it is assumed that the item of unidirectional content itself includes an audio soundtrack with a sampling rate of at least 42,000 Hz to represent ultrasonic frequencies, which are typically considered to be in the range of 18,000-21,000 Hz. It may be appreciated by one skilled in the art that the technique will work for any given audio range and that the invention is not limited to only ultrasonic frequencies. However, the use of ultrasonic frequencies for encoding an ID sound code is desirable as it will not create a noise that is audible to a viewer as might occur if frequencies in the audible range are used for this purpose.

ICS server 130 provides the ID sound code to producer computer 110. Producer computer 110 then creates the final form of the associated or corresponding item of unidirectional content by multiplexing or combining the ID sound code with any other audio tracks being mixed into the content. The resulting content then includes an ID sound code that is uniquely associated with an interaction manifest stored by ICS server 130. In certain embodiments, there may be a different ID sound code for each scene, act, segment or section of an item of unidirectional content.

Communications between producer computer 110, ICS server 130 and mobile device 170 typically occur across a digital network 120 such as the Internet.

A distributor 140 distributes an item of unidirectional content to content player 160 using a distribution facility. A distribution facility may be a separate transmission network such as a satellite network or broadcast network or it may use network 120. Also, as previously mentioned, a distribution facility may use distribution methods such as downloading or even mailing a DVD. As previously mentioned, distributor 140 and producer computer 110 may be the same entity using the same facilities or may be different entities using separate facilities. Producer computer 110 typically uploads final form media to distributor 140 across network 120 or may store the media in a network-accessible location, such as a storage facility accessible across the Internet.

Content player 160 receives a distribution of an item of unidirectional content, such as a television program from distributor 140 and plays the content within a physical venue 150 for a viewer. Content player 160 is capable of playing content with an audio track that includes ultrasonic frequencies, nominally in the 18,000 to 21,000 Hz range.

For best use of the subject system it is assumed that the viewer has a mobile device 170 with a ICS app 172 in operation. Further, it is assumed that mobile device 170 is equipped with an acoustic receiver for receiving the acoustic portion of the content being distributed by content player 160. Further, the acoustic receiver is capable of receiving ultrasonic frequencies, nominally in the 18,000 to 21,000 Hz range, indicating a sampling rate of at least 42,000 Hz.

ICS app 172 continuously monitors an incoming audio stream received by mobile device 170. ICS app 172 uses an ID decoder 174 to identify an ID sound code embedded in the incoming audio stream. ID decoder 174 decodes the embedded sound code to extract an alphanumeric interaction ID when such an interaction ID is present. Upon identifying an interaction ID, ICS App 172 issues a request to ICS server 130 for the interaction manifest that corresponds to the identified interaction ID.

Then, ICS interactor 132 obtains the corresponding interaction manifest and provides it to ICS app 172.

ICS app 172 executes the interaction manifest which enables the producer to provide related information to the viewer using mobile device 170. ICS app 172 operates in conjunction with ICS interactor 132 to provide information, enable the user to enter information, make selections, and provides information to ICS interactor 132 that can be stored and then gathered by producer computer 110 and/or distributor 140.

Examples of the types of interactions that ICS app 172, working in conjunction with ICS interactor 132, implements are given in Table 1 below.

TABLE 1
Example Interactions

| Type of | |
|---|---|
| Interaction | Description |
| Provide Information | Display related information to the |
| | viewer on the mobile device |
| | display. |
| Voting | Enable the viewer to select from |
| | alternative sentiments concerning |
| | the associated content, e.g. Like, |
| | Don't Like, Agree, Disagree |
| Obtain Viewer | Enable user to provide their |
| details | contact information to receive |
| | additional information |
| Purchase | Enable viewer to purchase |
| | related products. |
| Games | Enable a viewer to play games. |
| Social media | Enable a viewer to obtain |
| | information and interact via |
| | social networks. |
| Post | Enable a viewer to post |
| | information, generate texts, etc. |

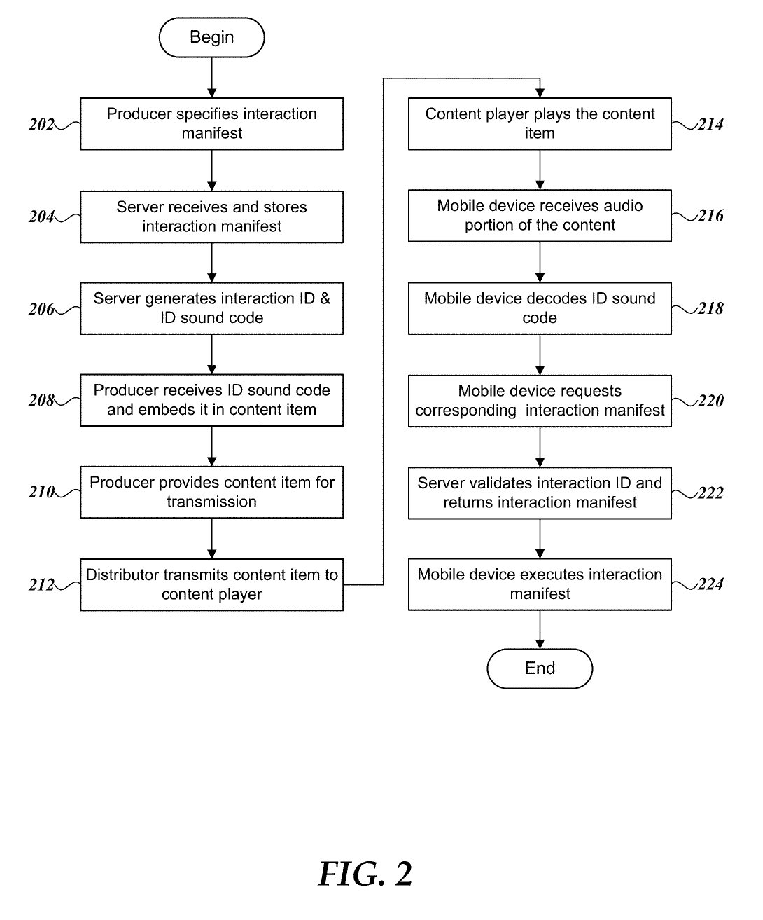

FIG. 2 is a generalized flow diagram of a method that provides interactive content to a viewer using a mobile device within a unidirectional media distribution environment Each graphical element, including rectangles, cylinders, and triangles, can be implemented by computer program instructions. These program instructions may be provided to a processor and then executed by the processor, thus creating means for implementing the actions represented by the graphical element. The computer program instructions may be executed by a processor to cause a series of operational steps to be performed by the processor to produce a computer-implemented process such that the instructions, which execute on the processor to provide steps for implementing the actions represented by the graphical element. Some of the computer program instructions may be performed in parallel, or across more than one processor, such as might arise in a multi-processor computer system. In addition, the actions represented by one or more graphical elements may also be performed concurrently with actions represented by other graphical elements, or even in a different sequence than illustrated without departing from the scope or spirit of the invention. It will also be understood that the actions represented by each graphical element and by combinations of graphical elements can be implemented by special purpose hardware-based systems that perform the specified actions or steps, or combinations of special purpose hardware and computer instructions.

At step 202 a producer, i.e. an individual, using producer computer 110, creates an interaction manifest. The interaction manifest identifies information such as: the item of unidirectional content that corresponds to the interaction manifest; a name for the interaction manifest; where in the timeline of the content an interaction should occur; whether it is a point interaction or a duration interaction (and if the latter, when it should end), and what sequence of actions should take place during the interaction specified by the interaction manifest. When the producer finishes creating the interaction manifest the producer computer 110 sends it to ICS server 130. An interaction manifest stored as one or more computer files.

At step 204, ICS server 130 receives the interaction manifest from producer computer 110 and stores it in database 136.

Upon receiving a new interaction, at step 206 server computer 130 generates an interaction ID that uniquely identifies the interaction manifest. ICS server 130 also generates an ID sound code, which is an audio file that represents the interaction ID. As previously discussed, in certain embodiments the ID sound code is constrained to ultrasonic frequencies.

At step 208 producer computer 110 receives the ID sound code and embeds it in the content item. Typically, this is accomplished using a content editing program that enables audio and video tracks to be merged to create one or more output files that are ready for distribution. Typically, the output files are in a standard format such as MPEG for a video or movie or MP3 or AAC for audio only but the invention is not limited to or dependent on the use of a particular type of file format.

At step 210, producer computer 208 produces the final form content item, with the embedded ID sound code for transmission by distributor 140. This step may be accomplished in a variety of ways. For example, the content item may be uploaded to a server, it may be emailed or provided using FTP or a Web service to distributor 140.

At step 212 distributor 140 distributes the content item to content player 160. As discussed, the term distribution encompasses a variety of means for providing a content item to a device capable of playing the content, including cable transmission, satellite transmission, distribution of a DVD or CD and the like.

At step 214 content player 160 plays the content item, including the embedded ID sound code to a viewer.

At step 216 the viewer's mobile device 170 receives the audio portion from content player 160. In certain embodiments, it is assumed that an ICS app 172 has been loaded and is already open on mobile device 170.

At step 218 mobile device 170, running ICS app 172 decodes the ID sound code to determine the interaction ID that corresponds to an interaction manifest. It may be appreciated that ICS app 172 was previously installed on mobile device 170. It may have been downloaded by the viewer; alternatively, it may have been pre-installed on mobile device 170.

At step 220, mobile device 170 includes the interaction ID in a request to server 130 for the corresponding interaction manifest.

At step 222, server 130 receives the request, validates that the interaction ID is authentic, retrieves the interaction manifest from database 136 and returns the interaction manifest to mobile device 170 for execution.

Finally, at step 224, mobile device 170 executes the interaction manifest, thus enabling the viewer to obtain related information, provide information, etc. in relation to the content item being played. As previously discussed, in certain embodiments, mobile device 170 relies on ICS app 172 to interpret and process the interaction script.

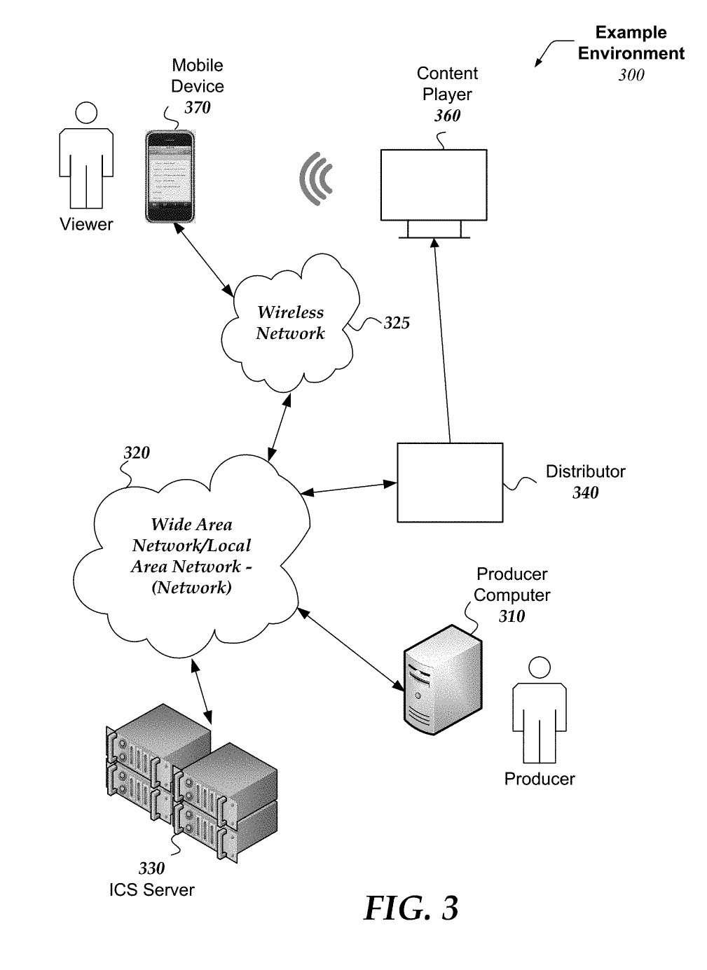

FIG. 3 is system diagram that illustrates components of one exemplary environment in which the invention may be practiced. Not all of the components may be required to practice the invention, and variations in the arrangement and types of the components may be made without departing from the spirit or scope of the invention.

As depicted, example environment 300 of FIG. 3 includes wide area network (“WAN”)/local area network (“LAN”)—(collectively referred to as “network”) 320, wireless network 325, a producer computer 310, a ICS server 330, a distributor 340, a content player 360, and a mobile device 370.

WAN/LAN network 320 together with wireless network 325 is an embodiment of network 120. Mobile device 370 is an embodiment of mobile device 170 which typically connects to wireless network 325 or to network 320. ICS server 330 illustrates an embodiment of ICS server 130. Producer computer 310 is an embodiment of producer computer 110. Distributor 340 is an embodiment of distributor 140. And, content player 360 is an embodiment of content player 160.

Generally, mobile device 370 includes any computing devices that are capable of receiving and sending messages over a wireless network, such as wireless network 325 including mobile phones, smart phones, tablet computers, laptop computers, desktop computers, wearable computers, and consumer electronics devices.

A Web-enabled mobile device can communicate across the World Wide Web (commonly referred to as the Web). It may include a browser application that is configured to receive and to send web pages, web-based messages, or the like. The browser application may send, receive and display graphics, text, multimedia, or the like, employing a network protocol such as Hypertext Transfer Protocol (HTTP) and/or wireless application protocol (WAP). Typically, a mobile device is capable of downloading applications, commonly referred to as apps. Typically, a mobile device downloads an app from an “app store” or other facility on the Web. After a mobile device downloads and installs an app, it is ready to be run or executed at the request of a user or viewer. In some cases, apps may execute in the background and do not need to be expressly launched by a user.

A mobile device may include one or more computer processors (CPUs), computer memory and nonvolatile data storage for storing program code and data, data storage such as a disk drive, or Flash memory drive and a network adapter or transceiver to connect to one or both of network 320 or wireless network 325. Computer memory may include RAM, DRAM, ROM, PROM, EPROM and the like.

Producer computer 310 is a client computer that is used by a producer to create content for distribution to content player 360. Devices that may operate as producer computer 310 include, but are not limited to personal computers, desktop computers, multiprocessor systems, laptop computers, tablet computers, smart phones, programmable consumer electronics, and the like.

Wireless network 325 is configured to couple a mobile device with network 320. Wireless network 325 may include any of a variety of wireless networks that provide a connection for mobile device 370. Such networks may include mesh networks, wireless LAN (WLAN) networks, cellular networks, satellite networks, or the like. Wireless network 325 may further include network devices such as gateways routers, or the like. In essence, wireless network 325 may include virtually any wireless communication device or mechanism that enables information to travel between mobile device 370 and another computing device, or between mobile device 370 and another network such as network 320.

Network 320 is configured to couple ICS server 320, producer computer 310 and distributor 340 with other computing devices, including through wireless network 325 to mobile device 370. Network 320 may include the Internet in addition to local area networks (LANs), wide area networks (WANs), direct connections, combinations thereof or the like.

ICS server 330 represents one or more network computing devices that are configured to receive and process messages and data from mobile device 370 and producer computer 310. Devices that may operate as ICS server 330 include, but are not limited to personal computers, desktop computers, multiprocessor systems, microprocessor-based or programmable consumer electronics, network PCs, servers, network appliances, and the like.

ICS server 330 typically includes one or more computer processors (CPUs), computer memory and nonvolatile data storage for storing program code and data, data storage such as a disk drive, or Flash memory drive and a network adapter or transceiver. Computer memory may include RAM, DRAM, ROM, PROM, EPROM and the like.

Although ICS server 330 is illustrated as a distinct network device, the invention is not so limited. For example, a plurality of network devices may be configured to perform the functions of ICS server 330. One such configuration is a “server farm” that includes multiple server computers operating cooperatively, each performing some of ICS server 330 server functions. One embodiment of the software modules executed by ICS server 330 is described with reference to FIG. 2 above.

ICS server 330 functions may also be provided by a cloud computing facility in which the services, features and functions ascribed herein to ICS server 330 are delivered as a service over a network, such as the Internet, rather than by a specific server or cluster of servers.

ICS server 330 is capable of running application programs (“applications”). Applications that may be run by ICS server 330 include transcoders, database programs, customizable user programs, security applications, encryption programs, VPN programs, web servers, applications servers, account management systems, and so forth.

ICS server 330 provides web services which include any of a variety of network services that are configured to provide content, including messages, over a network to another computing device. Thus, web services may include an application server, a web server, a messaging server, a File Transfer Protocol (FTP) server, a database server, a content server, or the like. Web services may provide the content including messages over the network using any of a variety of formats, including, but not limited to WAP, HDML, WML, SGML, HTML, XML, cHTML, xHTML, JSON, REST, SOAP or the like. Web services may also include server-side scripting languages such as PHP, Python, and Java servlets. Web services may also include the server side of the Ajax web development method that enables a server to asynchronously respond to Ajax requests.

Data storage provided by ICS server 330 may include virtually any mechanism usable for storing and managing data, including but not limited to a file, a folder, a document, a web page or an application, such as a database, digital media including digital images and digital video clips, and the like.

Data storage may further include a plurality of different data stores. Further, data storage may also include network storage or cloud storage in which the physical storage media, such as disk storage, is accessed across a network.

Distributor 340 transmits or distributes content created by a producer using producer computer 310. Distributor 340 may be a television broadcast facility, a movie studio that distributes films, a facility that distributes CD or DVDs. Generally, the detailed configuration and operation of distributor 340 is outside the scope of the subject invention.

Content player 360 plays content created by a producer using producer computer 310. In certain embodiments, content player 360 is a one-way device, i.e. it plays content but doesn't receive information back from the viewer that it relays back to a producer or distributor. Examples of devices that can act as content player 360 include televisions, radios, computer monitors connected to a network or personal computer. Content player 360 has the ability to play the audio portion of content created using producer computer 310. To this end, content player 360 may be connected to speakers or a home stereo or surround sound system.

While the preceding description of the invention focuses on enabling second screen interactions for broadcast television, the invention is not so limited. Generally, the invention is suitable for and may be applied to any one-way, or broadcast, content distribution mechanism including inter alia broadcast radio, Internet radio, DVDs, CDs, and cable TV.

Further, while the preceding description describes a way to embed an interaction ID in the acoustic portion of content, the invention is not so limited. For example, in other embodiments, the interaction ID may be embedded in the video portion or may be inserted into a digital transmission using a variety of encoding techniques.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for interacting with unidirectionally distributed content, comprising:
maintaining a database of interaction manifests, each interaction manifest having a corresponding interaction ID;
specifying an interaction manifest by a producer computer, the interaction manifest corresponding to an item of unidirectional content;
receiving, by a server computer from the producer computer, the interaction manifest;
generating, by the server computer an interaction ID that corresponds to the interaction manifest and a corresponding ID sound code;
embedding, by the producer, the ID sound code in the audio portion of the corresponding item of unidirectional content;
playing by a content player the item of unidirectional content which includes the embedded ID sound code;
receiving by a mobile device that is in proximity to the content player an audio portion of the item of unidirectional content;
decoding, by the mobile device, the embedded ID sound code to obtain the interaction ID;
requesting from the computer server the interaction manifest that corresponds to the interaction ID; and
executing, by the mobile device, the interaction manifest.

2. The method of claim 1 further comprising determining by the mobile device that the audio portion includes the embedded ID sound code.

3. The method of claim 1 wherein an interaction ID is a sequence of alphanumeric characters and a corresponding ID sound code corresponds to a sequence of frequencies wherein each of the frequencies in sequence corresponds to one character in the alphanumeric string and each frequency in the sequence is in the ultrasonic range.

4. The method of claim 3 wherein embedding the ID sound code comprises multiplexing the sequence of frequencies, each frequency lasting a predetermined time period, with the audio portion of the corresponding item of unidirectional content.

5. The method of claim 3 wherein the ultrasonic range includes frequencies in the range of 18,000 to 21,000 Hz.

6. The method of claim 1 wherein an item of unidirectional content is selected from the group consisting of a television program, a radio program, a cable television program, a cable radio program, a satellite television program, and a satellite radio program.

7. The method of claim 1 wherein a content player is a device selected from the group consisting of a television, a radio, a specialized video or audio players, a personal computer, and a mobile device.

8. The method of claim 1 wherein an interaction manifest specification of an action or sequence of actions to be performed or played by a mobile device.

9. A system for interacting with unidirectionally distributed content, comprising:
a database of interaction manifests, each interaction manifest having a corresponding interaction ID;
a server computer for:
receiving from a producer computer an interaction manifest, the interaction manifest corresponding to an item of unidirectional content;
storing the received interaction manifest in the database of interaction manifests;
generating (1) an interaction ID that corresponds to the received interaction manifest and (2) an ID sound code that corresponds to the interaction ID;
providing the ID sound code to the producer computer to embed in the audio portion of the corresponding item of unidirectional content;
a content player for receiving the item of unidirectional content that includes the embedded ID sound code and playing the item;
a mobile device for:
receiving an audio portion of the item of unidirectional content from the content player;
decoding, by the mobile device, the embedded ID sound code to obtain the interaction ID;
requesting from the computer server the interaction manifest that corresponds to the interaction ID; and
executing, by the mobile device, the interaction manifest.

10. The system of claim 9 further comprising determining by the mobile device that the audio portion includes the embedded ID sound code.

11. The system of claim 9 wherein an interaction ID is a sequence of alphanumeric characters and a corresponding ID sound code corresponds to a sequence of frequencies wherein each of the frequencies in sequence corresponds to one character in the alphanumeric string and each frequency in the sequence is in the ultrasonic range.

12. The system of claim 11 wherein embedding the ID sound code comprises multiplexing the sequence of frequencies, each frequency lasting a predetermined time period, with the audio portion of the corresponding item of unidirectional content.

13. The system of claim 11 wherein the ultrasonic range includes frequencies in the range of 18,000 to 21,000 Hz.

14. The system of claim 9 wherein an item of unidirectional content is selected from the group consisting of a television program, a radio program, a cable television program, a cable radio program, a satellite television program, and a satellite radio program.

15. The system of claim 9 wherein a content player is a device selected from the group consisting of a television, a radio, a specialized video or audio players, a personal computer, and a mobile device.

16. The system of claim 9 wherein an interaction manifest specifies an action or sequence of actions to be performed by a mobile device.
